(19) United States
(12) Patent Application Publication
(10) Pub. No.: US 2006/0221223 A1
(43) Pub. Date: Oct. 5, 2006

(54) Digital camera capable of continuous shooting and control method for the digital camera

(76) Inventor: Hiroshi Terada, Tokyo (JP)

Correspondence Address: STRAUB & POKOTYLO, 620 TINTON AVENUE, BLDG. B, 2ND FLOOR, TINTON FALLS, NJ, 07724, US

(21) Appl. No.: 11/385,433

(22) Filed: Mar. 21, 2006

(30) Foreign Application Priority Data
Apr. 5, 2005 (JP) 2005-109015
Apr. 5, 2005 (JP) 2005-109012

(51) Int. Cl. H04N 5/235

(52) U.S. Cl. 348/333.05; 348/362; 348/333.11

(57) ABSTRACT

According to the present invention, a digital camera capable of displaying a list of a plurality of images has a selection assist function for assisting an operator in selecting a desirable image from the images listed. As an example of the selection assist function, the digital camera can analyze plural images captured under different shooting conditions to display an image that seems optimum (or images that seem improper) in a way different from the other images. As another example of the selection assist function, the digital camera can have a function for displaying images while scaling up them around an area that can be an image selection point (e.g., focusing point or a point selected by the operator).

### CROSS-REFERENCE TO RELATED APPLICATION

This application is based upon and claims the benefit of priority from prior Japanese Patent Application Nos. 2005-109012, filed on Apr. 5, 2005; 2005-109015, filed on Apr. 5, 2005, the entire contents of which are incorporated herein by reference.

### BACKGROUND OF THE INVENTION

1. Field of the Invention

The present invention relates to a digital camera for displaying a group of images captured by performing shooting continuously plural times.

2. Description of the Related Art

Cameras capable of shooting continuously plural times are conventionally known.

For example, single-lens reflex (SLR) type cameras (hereinafter simply called “SLR cameras”) perform shooting by moving, once for each frame, a built-in quick return mirror to a position where it is withdrawn out of the optical path. On the other hand, another type of SLR cameras is also known, in which the quick return mirror is kept up with one press of a shutter button to perform continuous shooting of plural frames. This type of technique is disclosed, for example, in Japanese Patent Laid-Open No. H08-278541. This publication discloses a camera capable of rapid shooting of plural frames with one drive of the mirror while keeping such a state that light passing through an optical system is incident on an image pickup device. Today, a camera capable of continuous shooting of about eight frames per second is in practical use.

Further, among digital cameras, there are cameras having a so-called bracketing function for shooting plural times while varying the shooting conditions, such as the exposure value, to obtain the optimum image.

For example, Japanese Patent Laid-Open No. 2001-285779 discloses a digital camera for shooting a subject continuously plural times while varying at least one of the shooting conditions. In this digital camera, a group signal is given to images in an image group captured in one continuous shooting operation, making it easy to select a target image based on the group signal.

In this type of digital camera, it is important that a user can find the best shot from a sequence of images easily and quickly after completion of continuous shooting. In order to find out the best shot from all the image shots, it is common practice that the user operates an image selection button to view and check the image shots on an LCD monitor one by one. However, this becomes very burdensome as the number of continuous shots increases.

Therefore, various ideas for displaying continuous image shots have been proposed, such as a method of displaying a plurality of small images at a time (multi-index display), a method of displaying, in a first-step selection operation, only a representative image (one or a predetermined number of images) captured in a continuous shooting mode, and a method of displaying the continuous image shots as a movie.

### BRIEF SUMMARY OF THE INVENTION

According to the present invention, a digital camera capable of displaying a list of a plurality of continuously shot images has a selection assist function for assisting an operator in selecting a desirable image from the images listed.

As an example of the selection assist function, the digital camera can analyze plural images captured under different shooting conditions to display an image that seems optimum (or images that seem improper) in a way different from the other images. The analysis of an image can be performed, for example, by creating a histogram plotting brightness (gray level) on the horizontal axis and the number of pixels on the vertical axis. From the histogram, the “overexposure” or “underexposure” of the image can be determined. Further, as the different display form, the image can be bordered, for example.

As another example of the selection assist function, the digital camera can have a function for displaying images while scaling up them around an area containing an image selection point (e.g., focusing point or a point selected by the operator).

In one aspect of the present invention, a digital camera capable of continuous shooting comprises, for example: an imaging part for capturing images of a subject continuously; a selection part for selecting an image, identified as meeting predetermined conditions, based on a histogram created for each of the plural images captured by the imaging part; and a display part for displaying a list of the plural images while displaying the selected image in a way different from the other images.

It can be configured that the selection part selects an image captured under the optimum exposure conditions based on the histogram. Alternatively, the selection part can also select an overexposed image, or an underexposed image, or both.

As an example of selection based on the histogram, the selection part can create a histogram for each of the plural images to compare histograms in terms of their frequency distributions in a predetermined range of the histograms. Further, as the different display form, the image selected by the selection part can be bordered and displayed.

In another aspect of the present invention, a digital camera capable of continuous shooting comprises, for example: a display part capable of displaying a plurality of images at the same time; a scale-up display instructing part for instructing scale-up display of a predetermined area in each image; and a display control part for performing the scale-up display of the same area in the plural images, being displayed on the display part, when the scale-up display instructing part instructs the scale-up display.

The area to be scaled up on the display screen can be an area containing a focusing point in the continuous shooting operation or an area containing a point specified through an operator's manual operation.

The present invention can also be understood as a digital camera control method.

According to the present invention, there can be provided a digital camera that allows an operator to select a desirable shot easily from a plurality of images.

### BRIEF DESCRIPTION OF THE SEVERAL VIEWS OF THE DRAWINGS

These and other features, aspects, and advantages of the apparatus and methods of the present invention will become better understood with regard to the following description, appended claims, and accompanying drawings where:

FIG. 1A is a front view of a digital camera according to a first embodiment of the present invention;

FIG. 1B is a side view of the digital camera according to the first embodiment of the present invention;

FIG. 2 is a perspective view of the appearance of the digital camera according to the first embodiment of the present invention as viewed from its backside;

FIG. 3 is a block diagram showing the structure of an electric system of the digital camera according to the first embodiment of the present invention;

FIG. 4 is a time chart for giving a detailed description of a basic imaging operation of the digital camera according to the first embodiment of the present invention;

FIG. 5 is a time chart for giving a detailed description of a shooting operation of the digital camera in a continuous shooting mode (five-frame continuous shooting) according to the first embodiment of the present invention;

FIG. 6 is a flowchart for giving a detailed description of the imaging (exposure) operation of the digital camera according to the first embodiment of the present invention;

FIG. 7 is a flowchart for giving a detailed description of a playback operation for playing back captured image data stored on a recording medium 49 according to the exposure operation of FIG. 6;

FIG. 8 is a flowchart for giving a detailed description of a sub-routine “continuous shot display” executed in step S32 in FIG. 7;

FIG. 9 is an illustration showing the relationship among multiple focusing points a to e on a finder screen;

FIGS. 10A to 10D are illustrations of captured image display screens;

FIG. 11 is a flowchart for giving a detailed description of an improved example of the sub-routine “continuous shot display” executed in step S32 in FIG. 7;

FIGS. 12A and 12B are illustrations showing such a state that a cursor is displayed on captured image display screens to set a center point of scaling up images on the captured image display screens;

FIGS. 13A and 13B are illustrations of the captured image display screens;

FIG. 14 is a flowchart for giving a detailed description of the imaging (exposure) operation of a digital camera according to a second embodiment of the present invention;

FIG. 15 is a flowchart for giving a detailed description of the imaging (exposure) operation of a digital camera according to a third embodiment of the present invention;

FIG. 16 is a flowchart for giving a detailed description of the playback operation for playing back captured image data stored on the recording medium 49 according to the exposure (imaging) operation of FIG. 15;

FIG. 17 is a flowchart for giving a detailed description of the sub-routine “continuous shot display” executed in step S232 in FIG. 16;

FIGS. 18A to 18E are illustrations showing images captured in a bracketing mode in the upper parts and calculated histograms in the lower parts;

FIG. 19 is an illustration of a multi-index display screen 100;

FIGS. 20A to 20E are illustrations showing images captured in the bracketing mode in the upper parts and calculated histograms in the lower parts; and

FIG. 21 is an illustration of a multi-index display screen 200.

### DETAILED DESCRIPTION OF THE PREFERRED EMBODIMENTS

Preferred embodiments of the invention are described below with reference to the accompanying drawings.

### First Embodiment

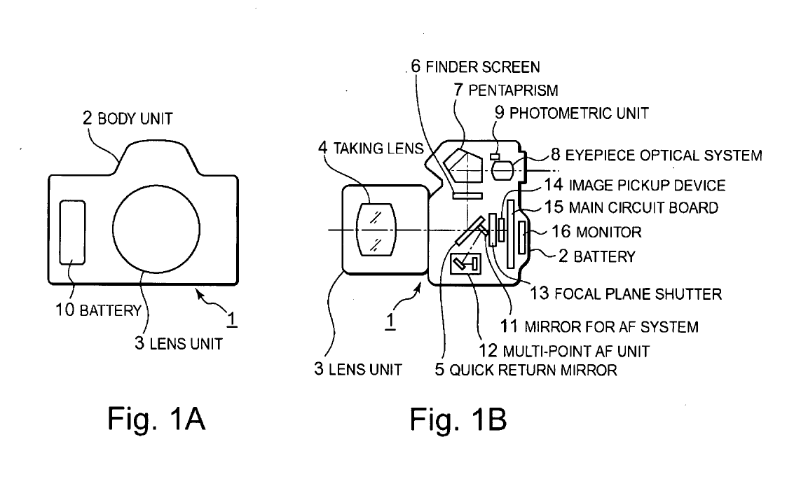

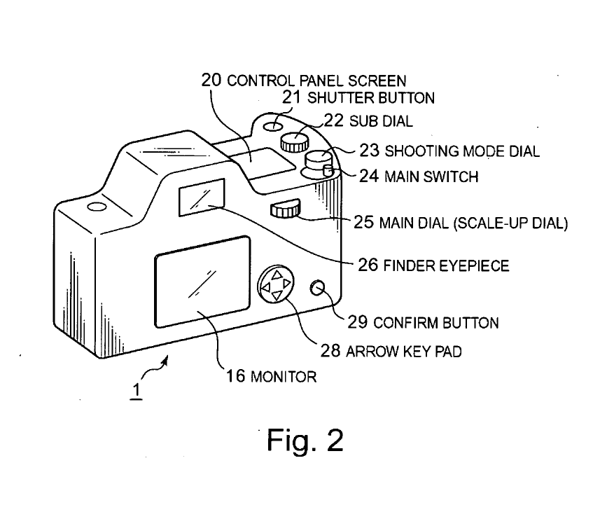

FIG. 1 shows the schematic structure of a digital camera according to a first embodiment of the present invention. Specifically, FIG. 1A is a front view of the digital camera and FIG. 1B is a side view of the digital camera. FIG. 2 is a perspective view of the appearance of the digital camera of FIG. 1 as viewed from its backside.

As shown in FIGS. 1A and 1B, this digital camera 1 has a body unit 2 and a lens unit 3 mountable on the body unit 2.

The lens unit 3 consists of a plurality of lenses, including a taking lens 4 for guiding a flux of light to an image pickup device 14 in the body unit 2 as described later.

On the other hand, a battery 10 is provided in the body unit 2 to supply power to each component in the body unit 2. A quick return mirror (reflecting mirror) 5 is provided on the optical path of the flux of light passing through the taking lens 4 to reflect the light flux. On the optical path of the reflected light from the quick return mirror 5, a finder screen 6, a pentaprism 7, and an eyepiece optical system 8 are arranged. A photometric unit 9 is provided near the eyepiece optical system 8. A mirror 11 for distance measurement (that is, for an AF system) is provided behind the quick return mirror 5. On the optical path of the reflected light from the mirror 11, a multi-point AF unit 12 is provided for automatic focusing at multiple points on a finder screen.

The central portion of the quick return mirror 5 is formed into a half mirror so that part of the light flux will pass through the half mirror portion when the quick return mirror 5 is moved to a down-position (first position) as shown in FIG. 1B. The mirror 11 is folded when the quick return mirror 5 is at an up-position (second position). Further, a focal plane shutter 13, the image pickup device (imager) 14, a main circuit board 15, and a monitor 16 are provided behind the quick return mirror 5 along the optical path of the flux light. The image pickup device 14 is a CCD or the like for photoelectrically converting the light of a subject image passing through the optical system. The image pickup device 14 and other components are arranged on the main circuit board 15. The monitor 16 is to display the subject image captured by the image pickup device 14.

Then, as shown in FIG. 2, a control panel screen 20, a shutter button 21, a sub dial 22, a shooting mode dial 23, a main switch 24, and a number-of-shots setting button 27 are provided on the top face of the body unit 2 of the digital camera 1. Further, a finder eyepiece 26, the monitor 16, a main dial (scaling-up dial) 25, a cross-shaped arrow key pad 28, and a confirm button 29 are provided on the backside of the body unit 2. The control panel screen 20 is to display shooting information and the like of the camera. The shutter button 21 consists of two-step release switches used for shooting operations of the camera. The main dial 25 and the sub dial 22 are used to select a mode or numeric value from various options. The main switch 24 is to switch on or off the power of the digital camera. The shooting mode dial 23 is to change exposure modes, for example, among program AE, aperture priority AE, shutter speed priority AE, and manual. The number-of-shots setting button 27 is to set the number of frames to be shot in a continuous shooting mode. For example, suppose that a single-frame shooting mode is set by default. In this case, for example, the number of frames can be set such that, when the number-of-shots setting button 27 is pressed once, the single-frame shooting is changed to five-frame continuous shooting, and when it is pressed at the second time, it returns to the default setting. The arrow key pad 28 is an instruction part used for setting various shooting conditions or playing back shot images. The confirm button 29 is used to confirm the various settings.

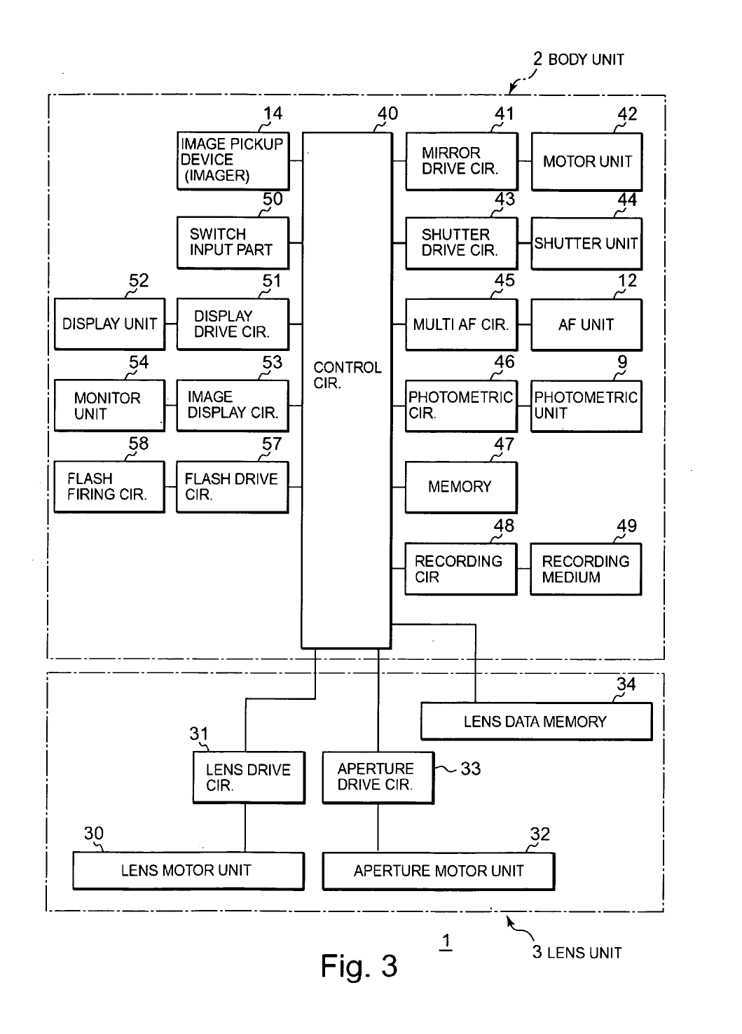

FIG. 3 is a block diagram showing the structure of an electric system of the digital camera according to the first embodiment of the present invention. As mentioned above, the digital camera 1 according to the embodiment includes the body unit 2 and the lens unit 3. The following describes each component.

The lens unit 2 has a lens motor unit 30, a lens drive circuit 31, an aperture motor unit 32, an aperture drive circuit 33, and lens data memory 34. The lens motor unit 30 moves the above-mentioned taking lens 4 along the optical axis. The movement of the taking lens 4 by the lens motor unit 30 is controlled by a control circuit 40 in the body unit 2 through the lens drive circuit 31 as described later. The aperture motor unit 32 is controlled by the control circuit 40 through the aperture drive circuit 33 to drive the aperture for limiting the amount of light incident on the image pickup device 14. The lens data memory 34 stores various data used for calculations such as the f-stop number indicating the opening size of the taking lens 4 and the focal length of the taking lens 4. These components in the lens unit 3 are controlled in accordance with instructions from the control circuit 40 in the body unit 2, respectively.

On the other hand, the body unit 2 has the control circuit 40 for controlling the operation of each component in the digital camera 1. The control circuit 40 is connected with the image pickup device (imager) 14, a mirror drive circuit 41, a shutter drive circuit 43, a multi-point AF circuit 45, a photometric circuit 46, a memory 47, a recording circuit 48, a switch input part 50, a display drive circuit 51, an image display circuit 53, and a flash drive circuit 57, as well as the above-mentioned components in the lens unit 3, namely the lens drive circuit 31, the aperture drive circuit 3, and the lens data memory 34.

The image pickup device 14 is an imager capable of multi-channel, high-speed reading. The mirror drive circuit 41 drives a motor unit 42 to move the quick return mirror 5 between the up-position and down-position. The shutter drive circuit 43 drives a shutter unit 44 containing the focal plane shutter 13. The shutter unit 44 is driven to open or close the focal plane shutter 13, that is, to control the shutter speed.

The multi-point AF circuit 45 drives the multi-point AF unit 12 to measure distances from the digital camera 1 to subjects (not shown). The photometric circuit 46 drives the photometric unit 9. The photometric circuit 46 performs photometric processing based on the flux of light from the pentaprism 7. The memory 47 stores predetermined camera control parameters and temporarily stores shot image data before being stored on a recording medium. The memory 47 is so provided that the control circuit 40 can access the control parameters and the image data. The recording circuit 48 is a circuit for recording images captured by image pickup device 14 on a recording medium 49 as image data.

The switch input part 50 includes the shutter button 21, the sub dial 22, the shooting mode dial 23, the main switch 24, the number-of-shots setting button 27, etc. The display drive circuit 51 drives a display unit 52 including the control panel screen 20 provided on the top face of the camera. The image display circuit 53 drives a monitor unit 54 including the monitor 16 provided on the backside of the camera. The flash drive circuit 57 controls the drive of a flash firing part 58.

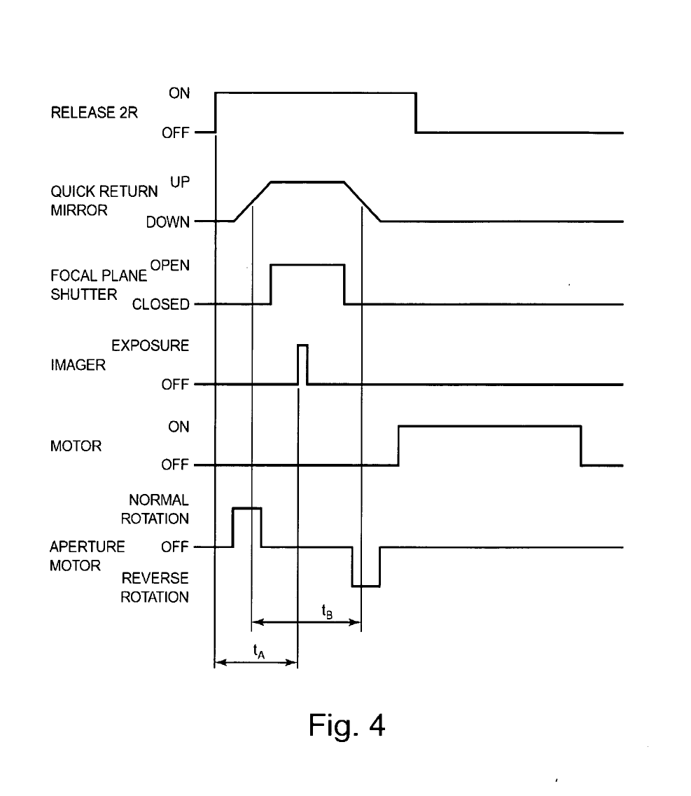

A basic imaging operation performed by the digital camera according to the first embodiment of the present invention is described in detail below with reference to a timing chart of FIG. 4. In FIG. 4, tA is a time lag from when a second shutter release is turned on until the image pickup device 14 is exposed, and tB is a period during which no finder image appears.

When the shutter button 21 is pressed down to turn on the second shutter release, the control circuit 40 starts driving an aperture motor to rotate in a normal direction after a predetermined lapse of time to narrow down an aperture (not shown) while moving the quick return mirror 5 to the up-position. When the quick return mirror 5 is flipped up, the control circuit 40 controls the shutter drive circuit 43 to drive the focal plane shutter 13 in the shutter unit 44 open. Then, after the lapse of tA, the control circuit 40 controls the image pickup device 14 to perform image pickup.

The quick return mirror 5 remains up for the period during which no finder image appears. After that, the control circuit 40 moves the quick return mirror 5 to the down-position, drives the aperture motor in a reverse direction to return the aperture to the initial state, turns the motor on to mechanically charge the shutter unit 44, and completes the operation of all components.

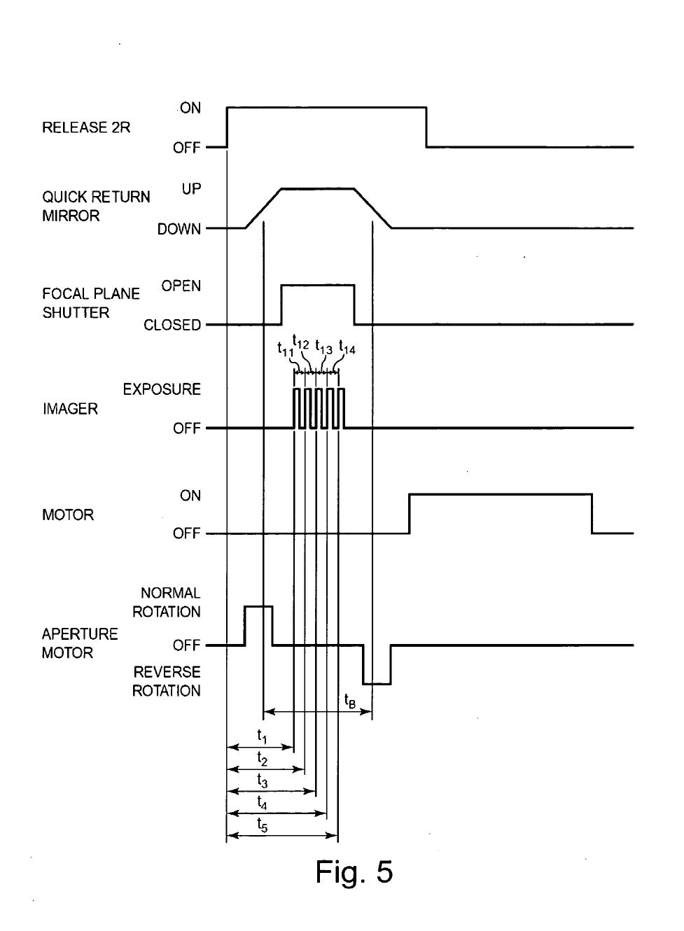

Next, the shooting operation of the digital camera in a continuous shooting mode (of five frames) according to the first embodiment of the present invention is described with reference to a timing chart of FIG. 5.

The following description may refer to the structural elements of FIGS. 1 to 3. In FIG. 5, tB indicates a period during which no finder image appears. tI1 is an interval between first and second frames, tI2 is an interval between second and third frames, tI3 is an interval between third and fourth frames, and tI4 is an interval between fourth and fifth frames (where tI1=tI2=tI3=tI4=2.0 msec), respectively. Further, t1 is a time lag from the second shutter release to shooting the first frame, t2 is a time lag from the second shutter release to shooting the second frame, t3 is a time lag from the second shutter release to shooting the third frame (corresponding to a normal shutter release lag time), t4 is a time lag from the second shutter release to shooting the fourth frame, and t5 is a time lag from the second shutter release to shooting the fifth frame, respectively.

When the shutter button 21 is pressed down to turn on the second shutter release, the control circuit 40 starts driving the aperture motor to rotate in the normal direction after a predetermined lapse of time to narrow down the aperture (not shown) while moving the quick return mirror 5 to the up-position. When the quick return mirror 5 is flipped up, the control circuit 40 controls the shutter drive circuit 43 to drive the focal plane shutter 13 in the shutter unit 44 open. Further, it controls the image pickup device 14 to perform image pickup continuously five times with shutter release time lags of t1, t2, t3, t4, and t5, respectively. In other words, in the continuous shooting mode, the control circuit 40 controls the operation of each component to perform shooting five times in total in such a manner to shoot once at the basic timing of the normal shooting mode (corresponding to the time lag t3), twice at predetermined intervals of tI2 (corresponding to the time lag t2) and tI3 (corresponding to the time lag t4) before and after the basic timing, and twice at predetermined intervals of tI1+tI2 (corresponding to the time lag t1) and tI3+tI4 (corresponding to the time lag t5) before and after the basic timing.

The quick return mirror 5 remains up for the period during which no finder image appears. After that, the control circuit 40 moves the quick return mirror 5 to the down-position, drives the aperture motor in the reverse direction to return the aperture to the initial state, turns the motor on to mechanically charge the shutter unit 44, and completes the operation of all components. In order to realize the above-mentioned continuous shooting operation, the first embodiment uses an imager with an imager shutter capable of continuous image pickup of about 500 frames per second.

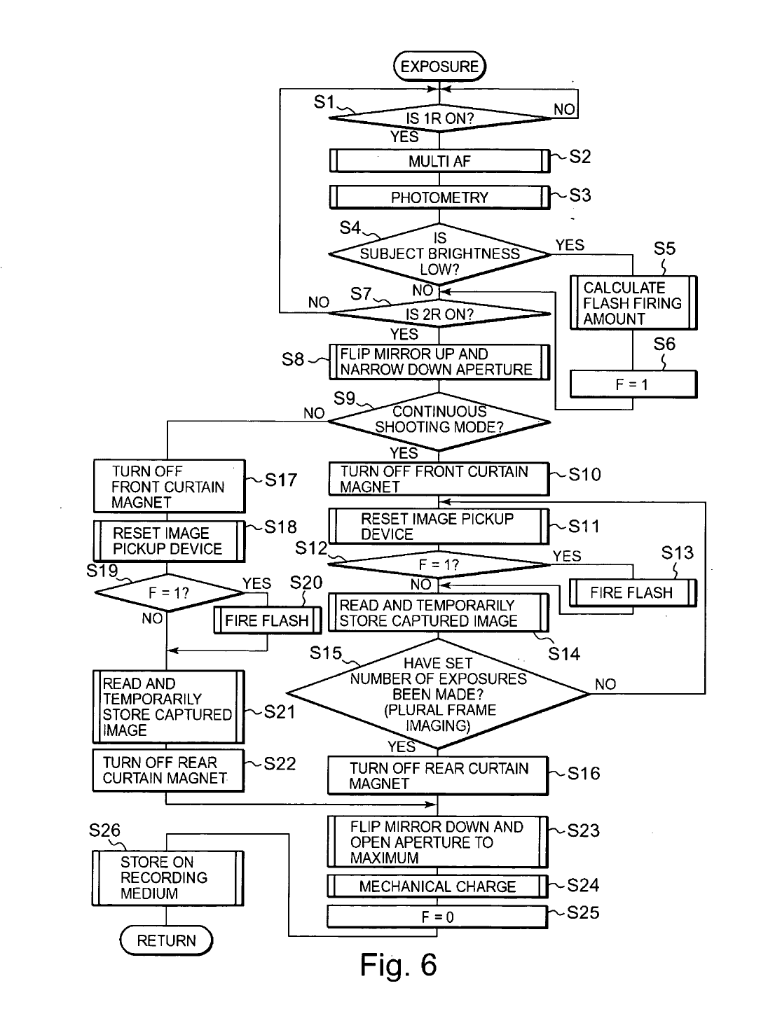

The shooting operation of the digital camera according to the first embodiment of the present invention is further described in detail below with reference to a flowchart of FIG. 6. The following description may refer to the elements of FIGS. 1 to 3.

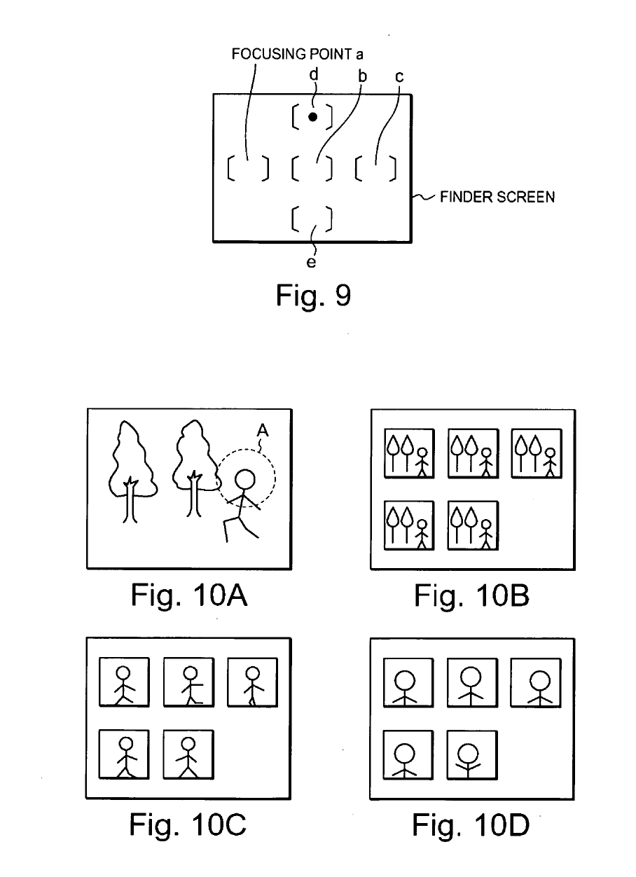

First, the control circuit 40 determines whether the operator presses the shutter button 21 halfway to turn on a first shutter release (hereinafter abbreviated as 1R) (step S1). If 1R is turned on, the multi-point AF unit 12 performs multi-point AF to measure distances to subjects at a plurality of points on a finder screen (see FIG. 9) so that the nearest subject will be focused (step S2), while the photometric unit 9 performs light metering (step S3). The control circuit 40 then determines whether the brightness of the subject is appropriate (that is, whether it is equal to or less than a predetermined threshold value) (step S4). If it is not appropriate (that is, if it is low), the amount of flash light is calculated (step S5), and a flag F for firing the flash is set to 1 (step S6). Then, the procedure proceeds to step S7, in which the control circuit 40 determines whether the operator fully presses the shutter button 21 to turn on the second shutter release (hereinafter abbreviated as 2R).

The processing from step S1 to step S7 is repeated until 2R is turned on.

When 2R is turned on (step S7), the control circuit 40 flips the quick return mirror 5 up while narrowing down the aperture (step S8). The control circuit 40 then determines whether the shooting mode is the continuous shooting mode (plural-frame shooting mode) (step S9).

If the shooting mode is the continuous shooting mode, the control circuit 40 turns off a shutter front curtain magnet in the shutter unit 44 (step S10), and resets the image pickup device 14 (step S11). The control circuit 40 then detects the state of the flag F related to flash firing (step S12). If F=1, the flash firing part 58 causes the flash to fire (step S13). On the other hand, if F=0, captured image data is read and temporarily stored in the memory 47 (step S14). The control circuit 40 repeats the processing from step S11 to step S14 a number of exposure times. After completion of the plural-frame image pickup and the exposure processing the set number of times (step 15), a shutter rear curtain magnet is turned off (step S16), and the procedure proceeds to step S23.

On the other hand, if the shooting mode is not the continuous shooting mode (step S9), the control circuit 40 turns off the shutter front curtain magnet in the shutter unit 44 (step S17), and resets the image pickup device 14 (step S18). The control circuit 40 then detects the state of the flag F related to flash firing (step S19). If F=1, the flash firing part 58 causes the flash to fire (step S20). After completion of flash firing, or if F=0 in step S19, captured image data is read and temporarily stored in the memory 47 (step S21). Then, the control circuit 40 turns off the shutter rear curtain magnet (step S22), and the procedure proceeds to step S23.

The control circuit 40 flips the quick return mirror 5 down while opening the aperture to the maximum (step S23). Then, it performs mechanical charge (step S24), sets the flag F related to flash firing to 0 (step S25), stores, on the recording medium 49, the captured image data temporarily stored in the memory 47, and ends this flow of operation.

Thus, according to the first embodiment, the digital camera equipped with the quick return mirror 5 and the control circuit 40 is provided. The quick return mirror 5 can move between the first position and the second position. The first position is to guide a flux of light from a subject to the finder/eyepiece optical system. The second position is to withdraw the quick return mirror 5 out of the optical path of the flux of light from the subject so that the quick return mirror 5 will guide the flux of light from the subject to the image pickup device 14. The control circuit 40 controls the image pickup device 14 to perform image pickup plural times for a predetermined period during which the quick return mirror 5 is at the second position. The digital camera can select either the single-frame shooting mode (normal mode) or the plural-frame shooting mode (continuous shooting mode). In the single-frame shooting mode, the image pickup device 14 performs image pickup once in the period during which the quick return mirror 5 is at the second position, while in the plural-frame shooting mode, the image pickup device 14 performs image pickup plural times in the above-mentioned predetermined period. In other words, according to the embodiment, the SLR digital camera equipped with the imager shutter can switch the number of shot frames selectively between one frame and plural frames in one driving sequence of the quick return mirror without changing the entire shooting sequence time. This allows the operator to select the plural-frame shooting and hence capture images of even a fast moving subject accurately.

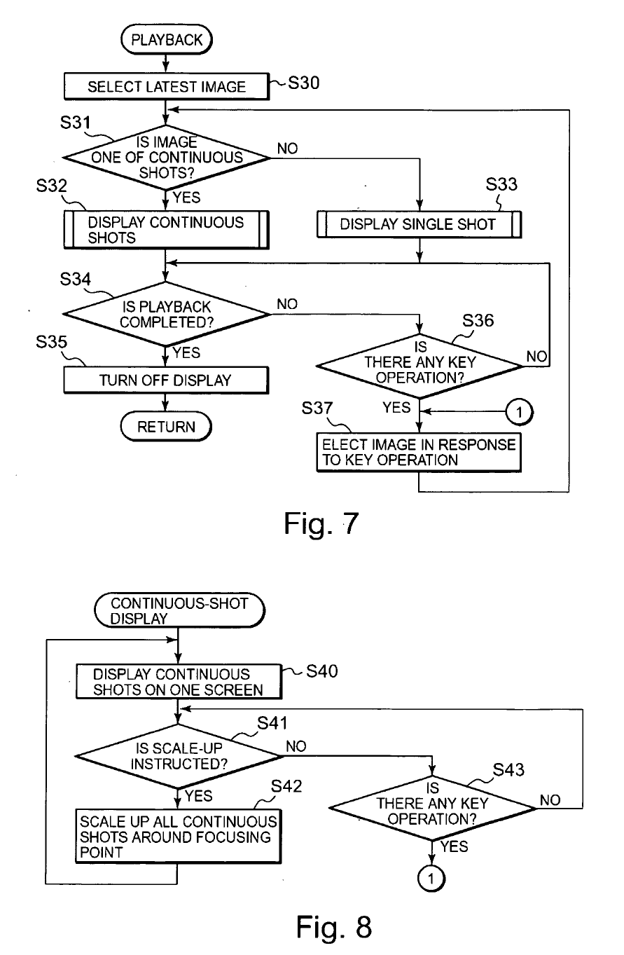

Next, the playback operation for playing back captured image data stored on the recording medium 49 in connection with the above-mentioned exposure operation is described in detail below with reference to a flowchart of FIG. 7.

First, when the operator operates the arrow key pad 28 to select the latest image (that is, the last shot image) (step S30), the control circuit 40 determines whether the image is one of the images captured in the continuous shooting mode (step S31). If the image is one of the images captured in the continuous shooting mode, a sub-routine “continuous shot display” is executed as described later (step S32).

On the other hand, if it is not one of the images captured in the continuous shooting mode, that is, if it is an image captured in the normal mode, signal shot display is performed (step S33).

Then, the control circuit 40 determines whether to complete the playback mode (step S34).

If determining that the playback mode is not to be completed, the control circuit 40 then determines the presence or absence of any other key operation on the arrow key pad 28 (step S36). If there is any other key operation on the arrow key pad 28, an image is selected in response to the key operation (step S37), and the procedure returns to step S31, while if there is no other key operation on the arrow key pad 28, the procedures returns to step S34.

Referring next to a flowchart of FIG. 8, the sub-routine “continuous shot display” executed in step S32 is described in detail. The following description is made while also referring to illustrations of FIGS. 9 and 10A to 10D.

In the sub-routine, the control circuit 40 first displays on one screen a list of a plurality of continuous image shots captured in the continuous shooting mode as shown in FIG. 10B (step S40). Then, the control circuit 40 determines whether a scale-up is instructed through a key operation on the arrow key pad 28 (step S41).

If determining that a scale-up is instructed, the control circuit 40 scales up all the continuous image shots around a focusing point in the first image (step S42). In this example, it is assumed that an area A circled with a broken line in FIG. 10A (corresponding to a focusing point c in the finder screen) corresponds to the focusing point in the first image of the continuous image shots. Then, as shown in FIG. 10C, the same area in all the continuous image shots is scaled up and the scaled-up images are displayed (step S40). Then, when a scale-up is instructed again through the key operation of the arrow key pad 28 (step S41), the area in all the continuous image shots is further scaled up and the further scaled-up images are displayed as shown in FIG. 10D (step S40).

Thus, the processing from step S40 to step S42 is repeated. If no scale-up is instructed and there is no other key operation on the arrow key pad 28, the procedure returns to step S41 to repeat the above-mentioned sequence of operations. Then, if any other key operation, such as selection of an image, is instructed through the arrow key pad 28, the procedure returns to step S37, an image is selected in response to the key operation on the arrow key pad 28.

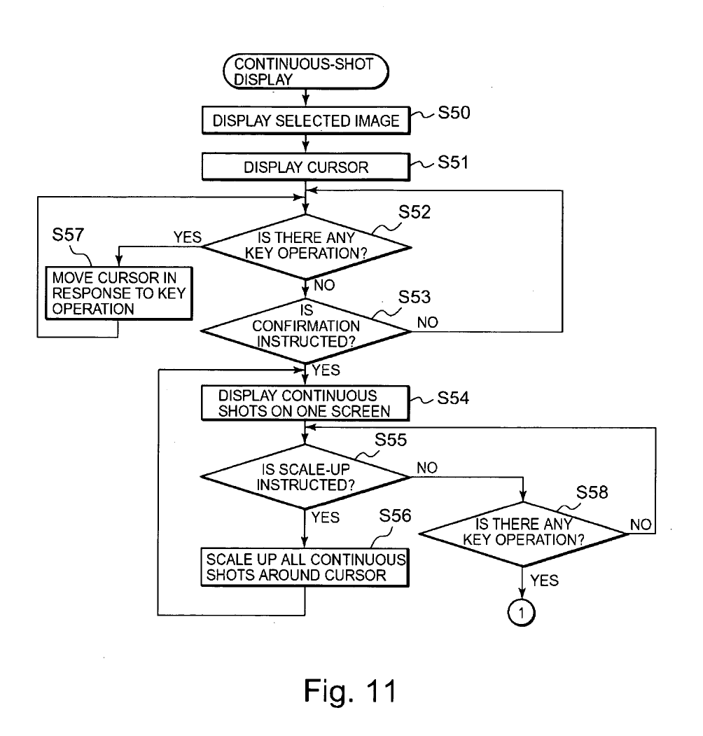

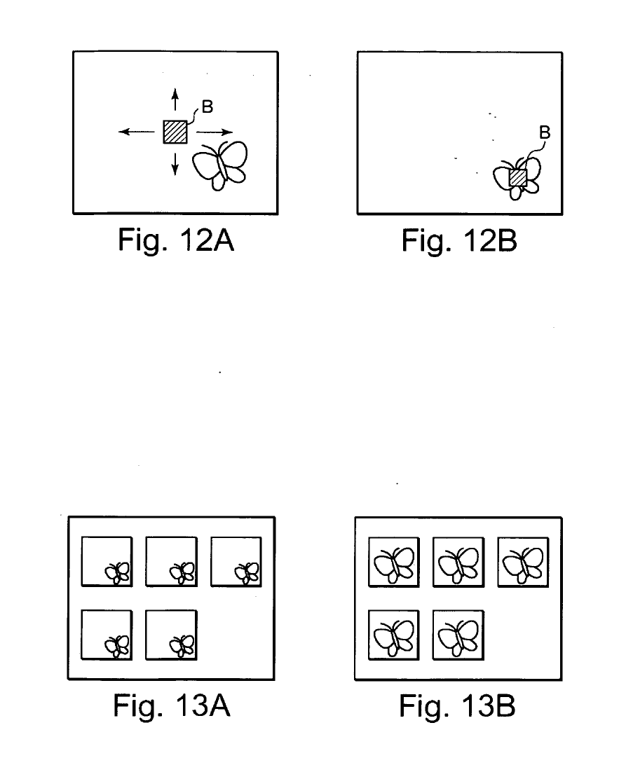

Referring next to a flowchart of FIG. 11, another example of the sub-routine “continuous shot display” executed in step S32 is described in detail. The following description is made while also referring to FIGS. 12A, 12B, and 13A, 13B for explaining how to change image screens.

In the above example, an area around the focusing point is automatically scaled up, while in this example, an area to be scaled up can be selected using a cursor.

In operation, an image selected from the continuous image shots is first displayed (step S50). As shown in FIG. 12A, a cursor B also appears on the display screen (step S51). The cursor can be moved in response to a key operation(s) on the arrow key pad 28 (steps S52 and S57). The control circuit 40 then determines whether the confirm button 29 has been pressed to confirm the instruction (step S53). If it is not pressed, the procedure returns to step S52 to repeat the above-mentioned sequence of operations until the instruction is confirmed.

If determining that the instruction is confirmed (step S53), the control circuit 40 displays on one screen a list of a plurality of continuous image shots captured in the continuous shooting mode as shown in FIG. 13A (step S54). Then, the control circuit 40 determines whether a scale-up is instructed through a key operation on the arrow key pad 28 (step S55).

If determining that a scale-up is instructed, the control circuit 40 scales up all the continuous shots around the cursor position (step S56). The scaled-up images of all the continuous shots are displayed as shown in FIG. 13B (step S54). Then, when the operator further presses any key on the arrow key pad 28 to instruct a scale-up again (step S55), all the continuous shots are further scaled up around the selected point (step S56). The scaled-up images of all the continuous shots are displayed (step S54).

The above-mentioned sequence of operations is repeated. If no scale-up is instructed and there is no other key operation on the arrow key pad 28, the procedure returns to step S54 to repeat the above-mentioned sequence of operations. On the other hand, if any other operation, such as image selection, is instructed through a key operation on the arrow key pad 28, the procedure returns to step S37 to select an image in response to the key operation on the arrow key pad 28.

Thus, according to the first embodiment, when a list of a plurality of shots captured in the continuous shooting mode is displayed on one screen, if the operator instructs a scale-up, the digital camera can scale up all the shots around a focusing point in a representative image (e.g., the first image of the continuous shots) or around a selected position, thus showing an index display of all the continuous shots. This is suitable for the operator to find the best shot. Note that the scale-up processing and the batch display processing can also be performed by setting a scale-up position in the representative image using the cursor. This is more suitable for the operator to find the best shot.

### Second Embodiment

A second embodiment features that a plurality of continuous shots on a multi-index display, that is, all continuous shots captured in the continuous shooting mode and displayed on one screen, are scaled up based on each focusing point, which varies from shot to shot according to the movement of a subject. Since the basic structure of the second embodiment is the same as that of the first embodiment (FIGS. 1 to 3), the following describes only a sequence of operations specific to the digital camera according to the second embodiment.

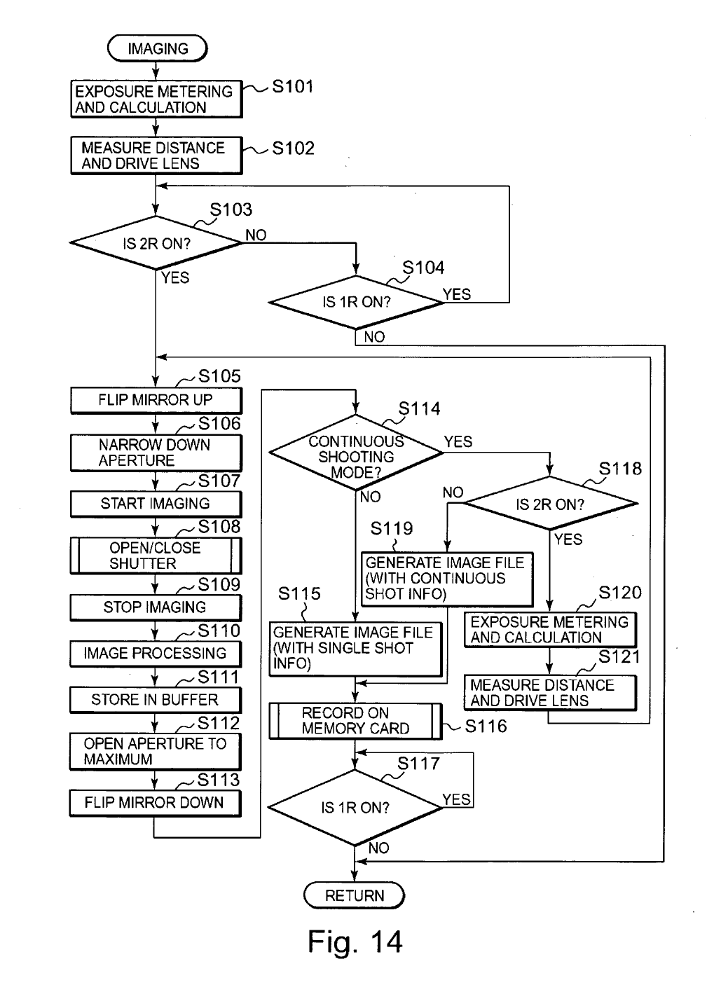

The imaging operation of the digital camera according to the second embodiment of the present invention is described in detail below with reference to the flowchart of FIG. 14. The following description may refer to the structural elements of FIGS. 1 to 3.

When the imaging operation is started in an imaging mode, the control circuit 40 first controls the photometric circuit 46 to perform exposure metering and calculation (step S101). Then, the control circuit 40 controls the multi-point AF circuit 45 to drive the multi-point AF unit 12 to measure distances to subjects (or a moving subject), calculates the amount of defocus, and controls the lens drive circuit 31 to drive a zoom lens in the taking lens 4 through the lens motor unit 30 (step S102). Following this step, when 1R is turned on with a half press of the shutter button 21 (step S104) and 2R is turned on with a full press of the shutter button 21 (step S103), the quick return mirror 5 is flipped up (step S105), and the aperture, not shown, is narrowed down (step S106) to start the imaging operation of the image pickup device 14 (step S107). Then, the focal plane shutter 13 is opened and closed (step S108), and the imaging operation of the image pickup device 14 is stopped (step S109). Then, image processing is performed (step S110), and captured image data is stored in the memory 47 (step S111). After that, the aperture, not shown, is opened to the maximum (step S112), and the quick return mirror 5 is flipped down (step S113). At this point, the control circuit 40 determines whether the shooting mode is the continuous shooting mode (step S114).

If the control circuit 40 determines that the shooting mode is not the continuous shooting mode, an image file is generated (with single shot information attached to it) (step S115), and recorded on the recording medium 49, such as a memory card, through the recording circuit 48 (step S116). Then, the control circuit 40 checks if the operator's finger is removed from the shutter button 21 based on the on/off state of 1R, and when it detects that the finger is removed (step S117), the control circuit 40 ends this flow of operation.

On the other hand, if the control circuit 40 determines in step S114 that the shooting mode is the continuous shooting mode and that 2R is not turned on (step S118), image files are generated (with continuous shot information attached to them) (step S119), and the procedure proceeds to step S116 to perform the above-mentioned operation steps.

If determining in step S118 that 2R is turned on, the control circuit 40 controls the photometric circuit 46 again to drive the photometric unit 9 to perform exposure metering and calculation (step S120). Then, the control circuit 40 controls the multi-point AF circuit 45 to drive the multi-point AF unit 12 to measure distances to the subjects (or the moving subject), calculates the amount of defocus, and controls the lens drive circuit 31 to drive the zoom lens in the taking lens 4 through the lens motor unit 30 (step S121). After that, the procedure returns to step S105 to repeat the above-mentioned operation steps.

Thus, according to the second embodiment, when the shooting mode is the continuous shooting mode, the digital camera performs the imaging operation while performing exposure metering and calculation, distance measurement, and lens driving for each shot. This makes it possible to scale up all shots based on each focusing point even when a plurality of continuous shots captured in the continuous shooting mode are displayed on one screen and all scaled up on the screen as described with respect to FIG. 10.

Note here that the present invention is not limited to the above-described first and second embodiments, and that various modifications and changes can be made without departing from the spirit of the invention. For example, all the continuous shots can be scaled up and displayed on one screen by setting scale-up positions in the first and last image shots so that all image shots between the first and last image shots will be scaled up around positions automatically calculated from the scale-up position information from both the first and last image shots. This is suitable for the operator to find the best shot in such a case when the operator shoots a moving subject in the continuous shooting mode because the continuous shots can be scaled up around the main subject and displayed on one screen.

### Third Embodiment

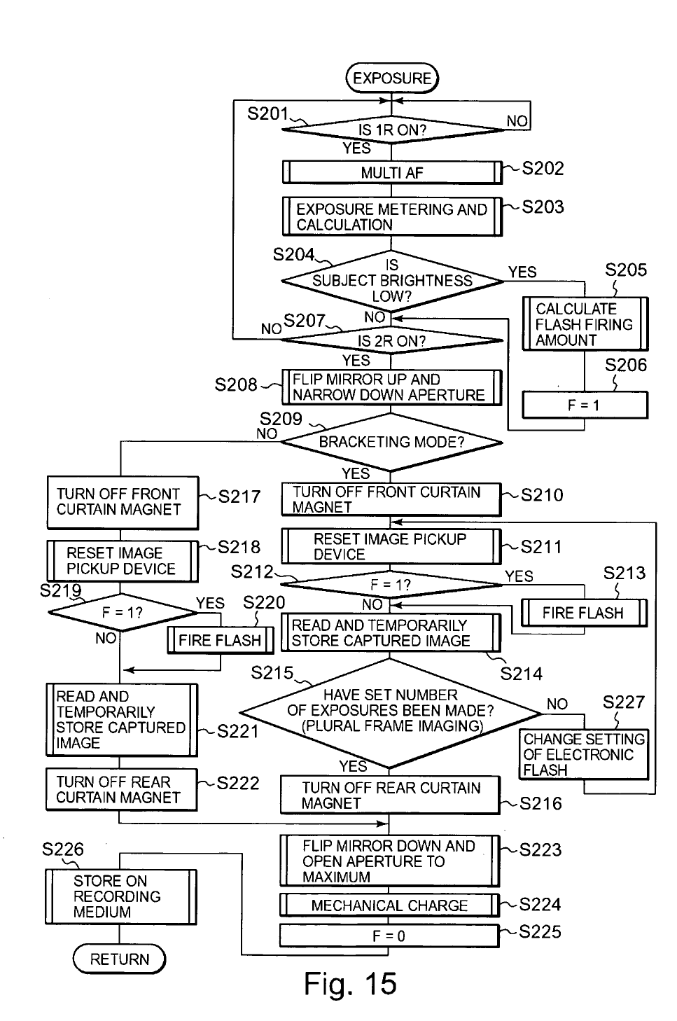

The imaging operation of a digital camera according to a third embodiment of the present invention is described in detail below with reference to a flowchart of FIG. 15. The following description may refer to the structural elements of FIGS. 1 to 3. The digital camera of the third embodiment has a bracketing mode.

First, the control circuit 40 determines whether the operator presses the shutter button 21 halfway to turn on 1R (step S201). If 1R is on, the multi-point AF unit 12 performs multi-point AF to measure distances to subjects at a plurality of points on the finder screen so that the nearest subject will be focused (step S202). Further, the photometric unit 9 performs light metering to calculate exposure conditions based on the metering results (step S203).

The control circuit 40 then determines whether the brightness of the subject is appropriate (e.g., whether it is equal to or less than a predetermined threshold value) (step S204). If it is not appropriate (that is, if it is low), the amount of flash light is calculated (step S205), and the flag F for firing the flash is set to 1 (step S206). Then, the procedure proceeds to step S207 to repeat the processing from step S201 to step S207 until 2R is turned on.

When 2R is turned on (step S207), the control circuit 40 flips the quick return mirror 5 up while narrowing down the aperture (step S208). The control circuit 40 then determines whether the shooting mode is the bracketing mode (for shooting plural frames while changing exposures around the optimum or calculated exposure) as one of the continuous shooting mode (step S209).

If the shooting mode is the bracketing mode, the control circuit 40 turns off the shutter front curtain magnet in the shutter unit 44 (step S210), and resets the image pickup device 14 (step S211). The control circuit 40 then detects the state of the flag F related to flash firing (step S212). If F=1, the flash firing part 58 causes the flash to fire (step S213). On the other hand, if F=0, captured image data is read and temporarily stored in the memory 47 (step S214).

Then, the control circuit 40 determines whether imaging is done a set number of exposure times (step S215). If imaging is not done the set number of times, the control circuit 40 changes the setting of the electronic flash (step S227), and repeats the processing starting from S211 under the changed conditions of the electronic flash. In other words, after the setting of the electronic flash is changed, the processing from step S211 to step S214 is repeated the set number of exposure times to perform plural-frame image pickup (step S215). After completion of the processing the set number of times, the control circuit 40 turns off the shutter rear curtain magnet (step S216), and procedure proceeds to step S223.

On the other hand, if determining in step S209 that the shooting mode is not the bracketing mode (step S209), the control circuit 40 turns off the shutter front curtain magnet in the shutter unit 44 (step S217), and resets the image pickup device 14 (step S218) The control circuit 40 then detects the state of the flag F related to flash firing (step S219). If F=1, the flash firing part 58 causes the flash to fire (step S220) After completion of flash firing, or if F=0 in step S219, the control circuit 40 reads and temporarily stores captured image data in the memory 47 (step S221). Then, the control circuit 40 turns off the shutter rear curtain magnet (step S222), and the procedure proceeds to step S223.

The control circuit 40 flips the quick return mirror 5 down while opening the aperture to the maximum (step S223) Then, it performs mechanical charge (step S224), sets the flag F related to flash firing to 0 (step S225), stores, on the recording medium 49, the captured image data temporarily stored in the memory 47, and ends this flow of operation.

Thus, according to the third embodiment, the digital camera equipped with the quick return mirror 5 and the control circuit 40 is provided. The quick return mirror 5 can move between the first position and the second position. The first position is to guide a flux of light from a subject to the finder (eyepiece) optical system. The second position is to withdraw the quick return mirror 5 out of the optical path of the flux of light from the subject so that the quick return mirror 5 will guide the flux of light from the subject to the image pickup device 14. The control circuit 40 controls the image pickup device 14 to perform image pickup plural times for a predetermined period during which the quick return mirror 5 is at the second position. The digital camera can select either the single-frame shooting mode (normal mode) or the plural-frame shooting mode (bracketing mode). In the single-frame shooting mode, the image pickup device 14 performs image pickup once in the period during which the quick return mirror 5 is at the second position, while in the plural-frame shooting mode, the image pickup device 14 performs image pickup plural times in the above-mentioned predetermined period. In other words, according to the embodiment, the SLR digital camera equipped with the imager shutter can switch the number of shot frames selectively between one frame and plural frames in one driving sequence of the quick return mirror without changing the entire shooting sequence time. This allows the operator to select the plural-frame shooting and hence capture images of even a fast moving subject accurately.

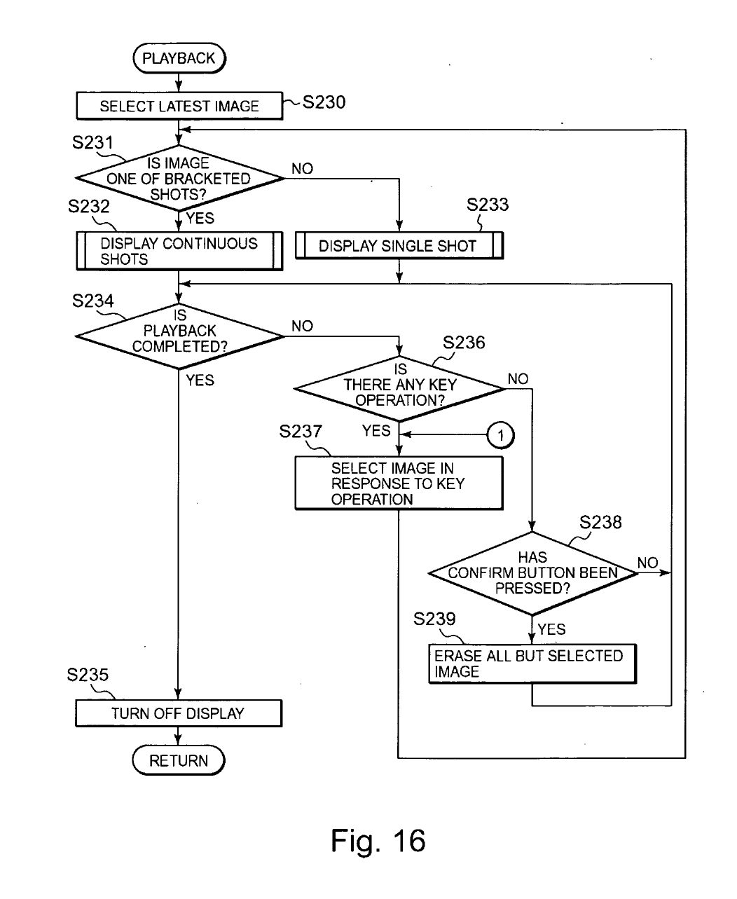

Next, the playback operation for playing back captured image data stored on the recording medium 49 in connection with the above-mentioned exposure operation is described in detail below with reference to a flowchart of FIG. 16.

First, when the operator operates the arrow key pad 28 to select the latest image (that is, the last shot image) (step S230), the control circuit 40 determines whether the image is one of the images captured in the bracketing mode (step S231). If the image is one of the images captured in the bracketing mode, a sub-routine “continuous shot display” is executed as described later (step S232).

On the other hand, if it is not one of the images captured in the bracketing mode, that is, if it is an image captured in the normal mode, single shot display is performed (step S233).

Then, the control circuit 40 determines whether to complete the playback mode (step S234).

If determining that the playback mode is not to be completed, the control circuit 40 then determines the presence or absence of any other key operation on the arrow key pad 28 (step S36). If there is any other key operation on the arrow key pad 28, an image is selected in response to the key operation (step S237), and the procedure returns to step S231. On the other hand, if determining in step S236 that there is no other key operation on the arrow key pad 28, the control circuit 40 further determines whether the confirm button has been pressed (step S238). If the confirm button 29 has been pressed, all but the selected image are erased (step S239), and the procedure returns to step S234 to repeat the above-mentioned sequence of operations. On the other hand, if the control circuit 40 determines in step S238 that the confirm button 29 is not pressed yet, the procedure returns to step S234 without going through step 239.

The processing of step S238 is to lock or protect an image the operator wants to leave among all the images on the recording medium at the press of the confirm button 29. All other unlocked images are erased automatically in step S239. Alternatively, the confirm button 29 can be used to specify images to be erased.

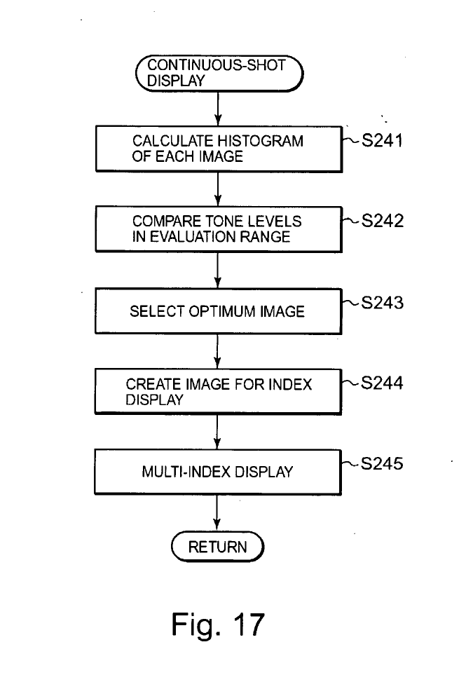

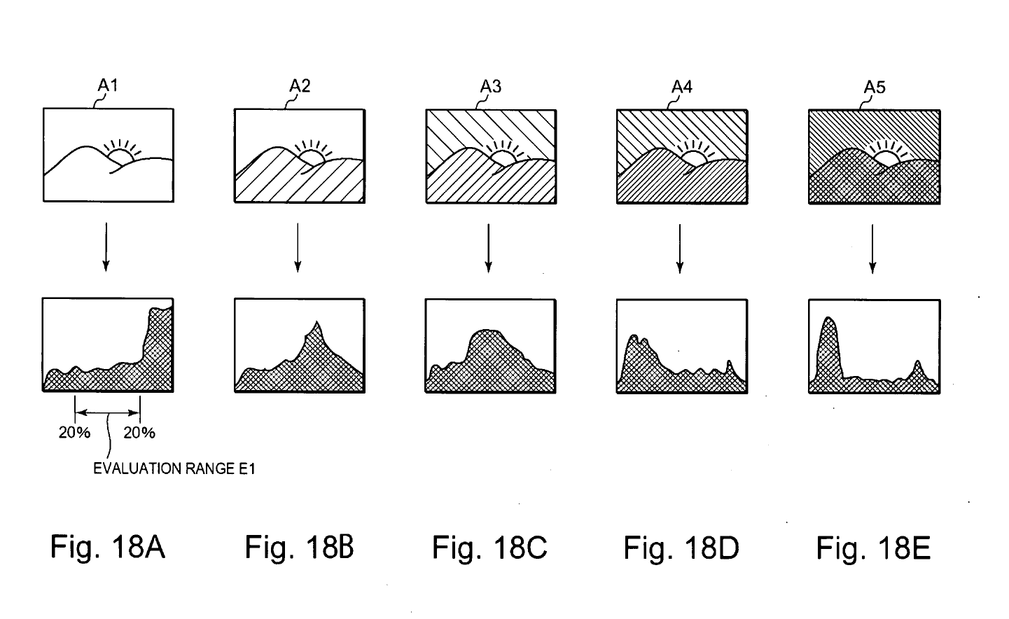

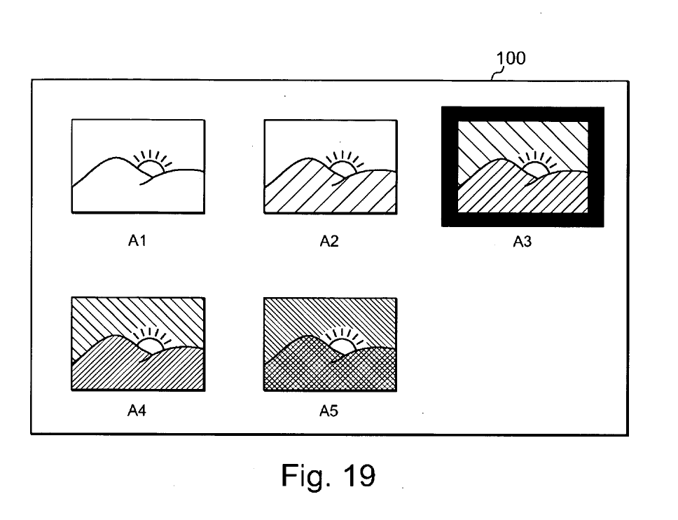

Referring next to a flowchart of FIG. 17, the sub-routine “continuous shot display” executed in step S232 is described in detail. This flowchart illustrates how to select the best frame. The following description is made while also referring to illustrations of FIGS. 18A to 18E and 19.

In the sub-routine, the control circuit 40 first calculates a histogram of each image of a plurality of continuous shot images (five frames in this example) captured in the bracketing mode and displayed on one screen (step S241). The term “histogram” means a bar chart representing a frequency distribution, which specifically means a bar chart representing the distribution of image data in terms of digital imaging. The distribution of image data is plotted in the bar chart indicating brightness (gray level) on the horizontal axis and the number of pixels on the vertical axis, representing a light-to-dark distribution of the image in the form of a chevron pattern. Since a digital image is represented by little dots called pixels, the brightness (gray level) and color are internally digitized (converted into numeric values). Therefore, the histogram is created by stacking dark dots on the left side and light dots on the right side. The scales of values on the horizontal and vertical axes are not fixed. For example, in case of a normal 8-bit RGB digital image, the horizontal axis is scaled from 0 to 255 (256 gray levels for each color) where 0 indicates pure black and 255 indicates pure white. The gray levels between the pure black and the pure white are represented by numeric values, and stacked on corresponding bars in the bar chart of the image. The histogram thus calculated allows the operator to grasp the tonality of the image in such a sense that the image is dark as the chevron pattern moves to the left or light as the chevron pattern moves to the right.

Returning to the description of the sub-routine, the control circuit 40 compares histograms in terms of their tone levels in an evaluation range E1 shown in FIG. 18A (step S242).

In the third embodiment, the evaluation range E1 is defined as the range in which a predetermined percentage of values from 0 (20% in this example) and a predetermined percentage of values from 255 (20% in this example) are removed from the entire range (0 to 255) on the horizontal axis indicating the brightness of the image. If a histogram shows a chevron pattern having a high frequency distribution on the side of the former removed range, the image is considered likely to be a so-called underexposed image in which the shadow areas are underexposed. On the other hand, if the histogram shows a chevron pattern having a high frequency distribution on the side of the latter removed range, the image is considered likely to be a so-called overexposed image in which the highlight areas are overexposed. In order to determine the optimum image, the evaluation range E1 with these ranges removed from the entire range is evaluated. In FIGS. 18A to 18E, the upper parts indicate images A1 to A5 captured in the bracketing mode, and the lower parts indicate histograms of respective images as a result of calculation. In this example, it can be determined from the calculation results that the image A3 has the highest frequency distribution in the evaluation range E1.

In this way, an image having the highest frequency distribution in the evaluation range E1 is selected from the plural images (step S243), images for index display are created (step S244) to show a multi-index display (step S245). After that, the flow is returned for the next processing.

In step S245, a multi-index screen 100 as shown in FIG. 19 is displayed. The control circuit 40 determines that the image having the highest frequency distribution in the evaluation range E1 is the best shot, that is, it selects the image A3 as the best shot from the images A1 to A5 shown in the upper parts of FIGS. 18A to 18E, and displays the screen 100 while highlighting the image A3 to indicate the operator that the image A3 is the best shot. The best shot can be highlighted in various ways, such as bordering it with white, bordering it with green, blinking with green light, etc.

The processing of FIG. 17 can also be modified in various ways.

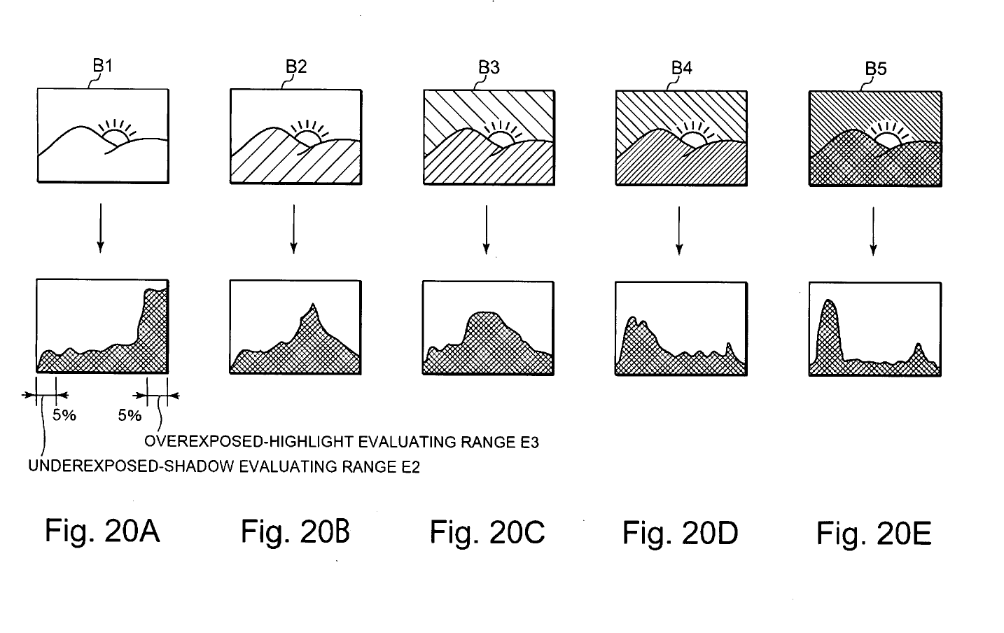

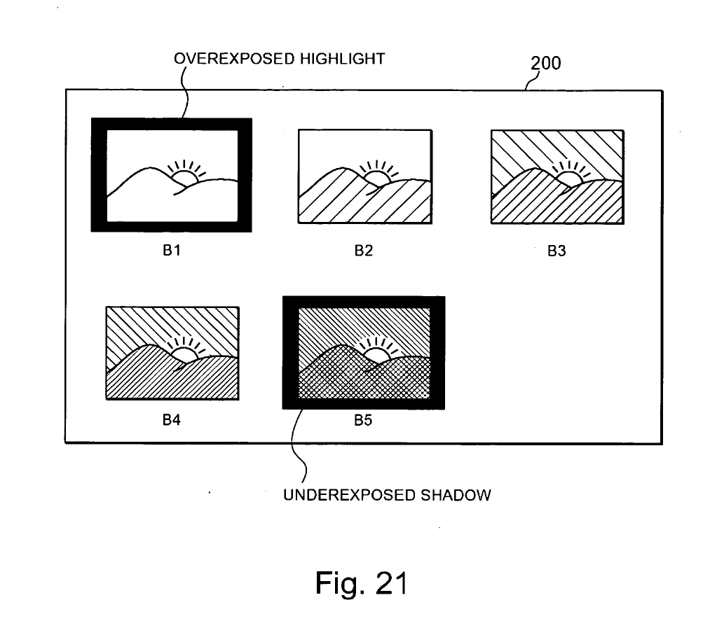

In the example of FIG. 17, the image having the highest frequency distribution in the evaluation range E1 is selected as the optimum image. Alternatively, an underexposed-shadow evaluating range E2 and an overexposed-highlight evaluating range E3 as shown in the lower part of FIG. 20A can be used instead of the evaluation range E1. In this case, an image having the highest frequency distribution in the underexposed-shadow evaluating range E2 is considered likely to be an underexposed image, while an image having the highest frequency distribution in the overexposed-highlight evaluating range E3 is considered likely to be an overexposed image. Therefore, these images can be displayed with warning signs on a screen 200 as shown in FIG. 21 to warn the operator. In this case, the processing steps 242 and 243 in the flowchart of FIG. 17 are replaced by the processing for selecting the underexposed and overexposed images based on the evaluation ranges E2 and E3.

In FIGS. 20A to 20E, images B1 to B5 captured in the bracketing mode are shown in the upper parts, and histograms of the images as a result of calculation are shown in the lower parts. In this example, from the calculation results, the image B1 having the highest frequency distribution in the evaluation range E3 is considered likely to be the overexposed image, while the image B5 having the highest frequency distribution in the evaluation range E2 is considered likely to be the underexposed image. Therefore, these images can highlighted on the screen 200 by bordering them with colors, such as white and red, or by blinking them.

As described in detail above, according to the third embodiment of the present invention, the control circuit 40 or the like as selection means selects an image captured under the optimum exposure conditions by comparing the histograms of the plural images captured by the image pickup device 14 as imaging means, so that a list of the plural images can be displayed on the monitor 16 as display means while displaying the selected image in a way different from the other images. This allows the operator to select the optimum image quickly. Alternatively, if the selection means selects both the overexposed and underexposed images based on the histograms, the operator can quickly select the images to be erased.

Note that the present invention is not limited to the above-described embodiments, and that various modifications and changes can be made without departing from the spirit of the invention.

For example, in the third embodiment, the optimum image is highlighted or the overexposed and underexposed images are displayed with warning signs, but the present invention is not limited thereto. Another parameter can be used to give priorities to the images in order from the highest to the lowest optimum level so that the images will be displayed while showing their priorities.

While there has been shown and described what are considered to be preferred embodiments of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. A digital camera capable of continuous shooting comprising:
an imaging part for capturing images of a subject continuously;
a selection part for selecting an image, identified as meeting predetermined conditions, based on a histogram created for each of the plural images captured by the imaging part; and
a display part for displaying a list of the plural images while displaying the selected image in a way different from the other images.

2. The digital camera according to claim 1 wherein the selection part selects an image captured under the optimum exposure conditions based on the histogram.

3. The digital camera according to claim 1 wherein the selection part selects an overexposed image, or an underexposed image, or both based on the histogram.

4. The digital camera according to claim 1 wherein the selection part creates a histogram for each of the plural images, and compares histograms in terms of their frequency distributions in a predetermined range of the histograms to select an image captured under the optimum exposure conditions.

5. The digital camera according to claim 1 wherein the selection part creates a histogram for each of the plural images, and compares histograms in terms of their frequency distributions in a predetermined range of the histograms to select an overexposed image, or an underexposed image, or both.

6. The digital camera according to claim 1 wherein the display part displays the image selected by the selection part while bordering the selected image.

7. A control method for a digital camera capable of continuous shooting comprising:
capturing images of a subject continuously;
selecting an image, identified as meeting predetermined conditions, based on a histogram created for each of the plural images; and
displaying a list of the plural images while displaying the selected image in a way different from the other images.

8. The method according to claim 7, wherein the selecting an image includes
creating a histogram for each of the plural images, and
selecting an image captured under the optimum exposure conditions based on the histogram.

9. The method according to claim 7, wherein the selecting an image includes
creating a histogram for each of the plural images, and
selecting an overexposed image, or an underexposed image, or both based on the histogram.

10. The method according to claim 7, wherein the selecting an image includes
creating a histogram for each of the plural images, and
comparing histograms in terms of their frequency distributions in a predetermined range of the histograms to select an image captured under the optimum exposure conditions.

11. The method according to claim 7, wherein the selecting an image includes
creating a histogram for each of the plural images, and
comparing histograms in terms of their frequency distributions in a predetermined range of the histograms to select an overexposed image, or an underexposed image, or both.

12. The method according to claim 7, wherein the displaying the selected image in a way different from the other images includes bordering the selected image.

13. A digital camera capable of continuous shooting comprising:
a display part capable of displaying a plurality of images at the same time;
a scale-up display instructing part for instructing scale-up display of a predetermined area in each image; and
a display control part for performing the scale-up display of the same area in the plural images, being displayed on the display part, when the scale-up display instructing part instructs the scale-up display.

14. The digital camera according to claim 13 wherein the area to be scaled up on the display screen is an area containing a focusing point in the continuous shooting operation.

15. The digital camera according to claim 13 wherein the area to be scaled up on the display screen is an area containing a point specified through an operator's manual operation.

16. A control method for a digital camera capable of continuous shooting comprising:
displaying a plurality of images at the same time;
instructing the execution of a scale-up display around a predetermined area in each image; and
performing the scale-up display of the same area in the plural images, when the scale-up display is instructed.

17. The method according to claim 16 wherein the performing scale-up displaying is to display an area around a focus point in the continuous shooting operation in scaled-up manner.

18. The method according to claim 16 wherein the performing scale-up displaying is to display an area specified through an operator's manual operation in scaled-up manner.
